(19) United States
(12) Patent Application Publication
(10) Pub. No.: US 2010/0199025 A1
(43) Pub. Date: Aug. 5, 2010

(54) MEMORY SYSTEM AND INTERLEAVING CONTROL METHOD OF MEMORY SYSTEM

(75) Inventors: Hiroyuki Nanjou, Kanagawa (JP); Tetsuya Murakami, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/558,965

(22) Filed: Sep. 14, 2009

(30) Foreign Application Priority Data
Feb. 2, 2009 (JP) 2009-022044

(51) Int. Cl. G06F 12/00; G06F 12/02

(52) U.S. Cl. 711/103; 711/158; 711/157; 711/E12.001; 711/E12.008

(57) ABSTRACT

A memory system comprising: a plurality of nonvolatile memory areas capable of operating individually; and a memory controller connected to each of the memory areas individually via a ready/busy signal for interleaving an operation in the memory areas by changing a memory area as a target of an operation command, every time the operation command is transmitted, wherein the memory controller includes a priority-level managing unit that manages a level of selection priority for each memory area, so that after transmission of an operation command, the memory controller selects a memory area with a highest level of selection priority from memory areas in a ready state, to change the selected memory area to a target of a next operation command, and shifts the level of selection priority of the selected memory area at a time of next selection to a lowest level by the priority-level managing unit.

### CROSS-REFERENCE TO RELATED APPLICATIONS

This application is based upon and claims the benefit of priority from the prior Japanese Patent Application No. 2009-022044, filed on Feb. 2, 2009; the entire contents of which are incorporated herein by reference.

### BACKGROUND OF THE INVENTION

1. Field of the Invention

The present invention relates to a memory system and an interleaving control method of a memory system.

2. Description of the Related Art

As a memory system used for a computer system, a solid state drive (SSD) having a nonvolatile semiconductor memory such as a NAND flash memory (hereinafter, “NAND memory”) incorporated therein has attracted attention. Memory systems such as an SSD have advantages such as higher operation speed and lightweight as compared to magnetic disk drives.

Recently, to improve transfer efficiency, a function of performing bank interleaving has been adopted. Specifically, a NAND memory incorporated in an SSD is divided into a plurality of memory areas (banks) capable of performing memory operations including data write at the same time, and a bank to be written with data is sequentially switched at the time of performing data write to the NAND memory continuously (see, for example, U.S. Patent Application Publication No. 2006/0152981).

### BRIEF SUMMARY OF THE INVENTION

A memory system according to an embodiment of the present invention comprises:

a plurality of nonvolatile memory areas capable of operating individually; and

a memory controller connected to each of the memory areas individually via a ready/busy signal for interleaving an operation in the memory areas by changing a memory area as a target of an operation command, every time the operation command is transmitted, wherein

the memory controller includes a priority-level managing unit that manages a level of selection priority for each memory area, so that after transmission of an operation command, the memory controller selects a memory area with a highest level of selection priority from memory areas in a ready state, to change the selected memory area to a target of a next operation command, and shifts the level of selection priority of the selected memory area at a time of next selection to a lowest level by the priority-level managing unit.

A memory system according to an embodiment of the present invention comprises:

a plurality of nonvolatile memory areas capable of operating individually; and

a memory controller connected to each of the memory areas individually via a ready/busy signal for interleaving an operation in the memory areas by changing a memory area as a target of an operation command, every time the operation command for performing a plurality of operations is transmitted, wherein

the memory controller includes a priority-level managing unit that manages a level of selection priority for each memory area, and an operation-state recognizing unit that recognizes whether the operation command is being performed based on the ready/busy signal, so that after transmission of the operation command, a memory area with a highest level of selection priority is selected from the memory areas, in which the operation command is not being performed, to change the selected memory area to a next memory area as a target of a next operation command, and shifts the level of selection priority of the selected memory area at a time of next selection to a lowest level by the priority-level managing unit.

An interleaving control method of a memory system according to an embodiment of the present invention comprises:

selecting a memory area with a highest level of selection priority from the memory areas in a ready state based on a level of selection priority of each memory area set beforehand, to designate the selected memory area as a memory area as a target of the operation command;

transmitting the operation command to the memory area as the target of the operation command; and

shifting the level of selection priority of the selected memory area at a time of next selection to a lowest level.

### BRIEF DESCRIPTION OF THE DRAWINGS

FIG. 1 depicts a configuration of an SSD according to a first embodiment of the present invention;

FIG. 2A is a configuration example of a physical block of a NAND memory;

FIG. 2B is an example of threshold distribution in a quaternary data storage system;

FIG. 3 is a schematic diagram for explaining an operation history of banks 0 to 3;

FIG. 4 is a schematic diagram for explaining a functional configuration of a NAND controller in the SSD according to the first embodiment and a relation of connection between the NAND controller and the NAND memory;

FIG. 5 is a timing chart for explaining a state of a Cont. I/O signal line and a state of a Ry/By signal line;

FIG. 6 is a specific configuration example of the NAND controller, taking into consideration parallel operations between channels when Ry/By signal lines for banks are commonly connected;

FIG. 7 is a flowchart for explaining an operation of banks of the SSD according to the first embodiment;

FIG. 8 is a flowchart for explaining an operation of a ch0 controller of the SSD according to the first embodiment;

FIG. 9 is a schematic diagram for explaining a change of an array of priority level;

FIG. 10 is a schematic diagram for explaining a configuration of a bank including a plurality of planes;

FIG. 11 is another timing chart for explaining a state of the Cont. I/O signal line and a state of the Ry/By signal line;

FIG. 12 is a schematic diagram for explaining a functional configuration of a NAND controller of an SSD according to a second embodiment of the present invention and a relation of connection between the NAND controller and a NAND memory;

FIG. 13 is a flowchart for explaining an operation of banks of the SSD according to the second embodiment;

FIG. 14 is a schematic diagram for explaining a recognition change of an operation state of a bank i; and

FIG. 15 is a flowchart for explaining an operation of a ch0 controller of the SSD according to the second embodiment.

### DETAILED DESCRIPTION OF THE INVENTION

The time required for a memory operation including data write to a NAND memory is different between chips due to a production tolerance or the like. Therefore, the time required for a data write operation can be different between banks. Even if bank interleaving is performed, as each bank is focused on, a blank time occurs during which any of a reception operation or a write operation of data is not performed due to a difference in time required for the write operation. It has been found by the present inventor that if the blank time occurs disproportionately in a specific bank, transfer speed of data with respect to the entire NAND memory decreases, and the transfer efficiency is degraded. In U.S. Patent Application Publication No. 2006/0152981, there is no description or suggestion of any technique for solving this problem.

Exemplary embodiments of a memory system and an interleaving control method of a memory system according to the present invention will be explained below in detail with reference to the accompanying drawings. The present invention is not limited to the following embodiments.

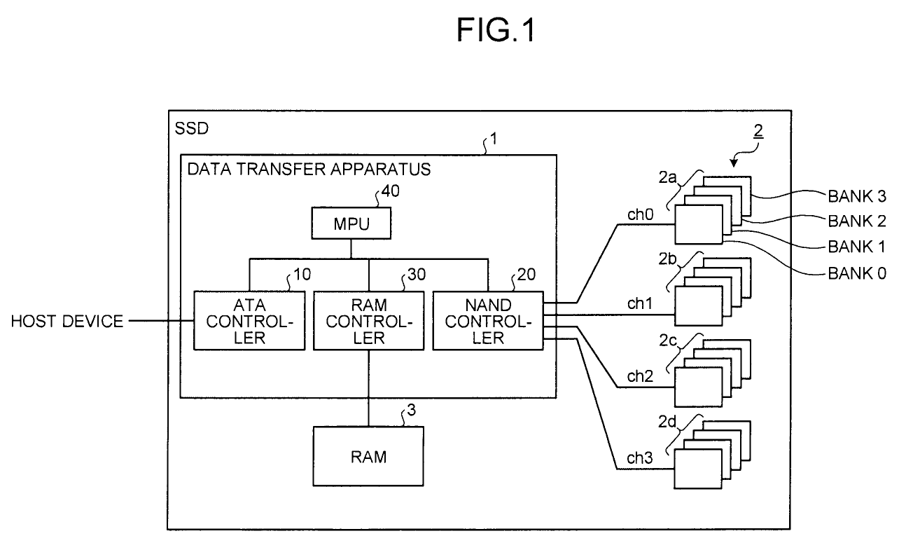

FIG. 1 is a block diagram of a configuration of a memory system according to a first embodiment of the present invention. An SSD is explained as an example of the memory system; however, an application target of the first embodiment is not limited to the SSD.

The SSD is connected to a host device such as a personal computer via an advanced technology attachment (ATA)-standard communication interface, and functions as an external storage unit of the host device. The SSD includes a NAND memory 2, which is a nonvolatile memory that stores data to be read or written by the host device, a data transfer apparatus 1 that performs data transfer control of the SSD, and a random access memory (RAM) 3, which is a nonvolatile memory that temporarily stores transfer data for data transfer by the data transfer apparatus 1. The data transmitted from the host device is stored once in the RAM 3 under control of the data transfer apparatus 1, and then read from the RAM 3 and written into the NAND memory 2.

The data transfer apparatus 1 includes an ATA interface controller (ATA controller) 10 that performs control of the ATA interface (I/F) and control of the data transfer between the host device and the RAM 3, a RAM controller 30 that controls read and write of data with respect to the RAM 3, a NAND controller 20 that performs control of the data transfer between the NAND memory 2 and the RAM 3, and a micro processing unit (MPU) 40 that performs control of the entire data transfer apparatus 1 based on firmware.

The NAND memory 2 has four parallel operation elements 2a to 2d that operate in parallel, and the parallel operation elements 2a to 2d are respectively connected to the NAND controller 20 via a signal line group (channels ch0 to ch3) independently. The parallel operation elements 2a to 2d are divided into bank 0 to bank 3, which are four memory areas capable of operating individually. Each bank includes one or more memory chips (NAND flash memory). For example, a configuration of including one chip, two chips, or four chips for each bank can be considered. Each memory chip includes a plurality of blocks (physical blocks), which is a minimum unit capable of erasing data independently. Each block includes a plurality of pages (physical pages), which is a unit capable of writing and reading collectively.

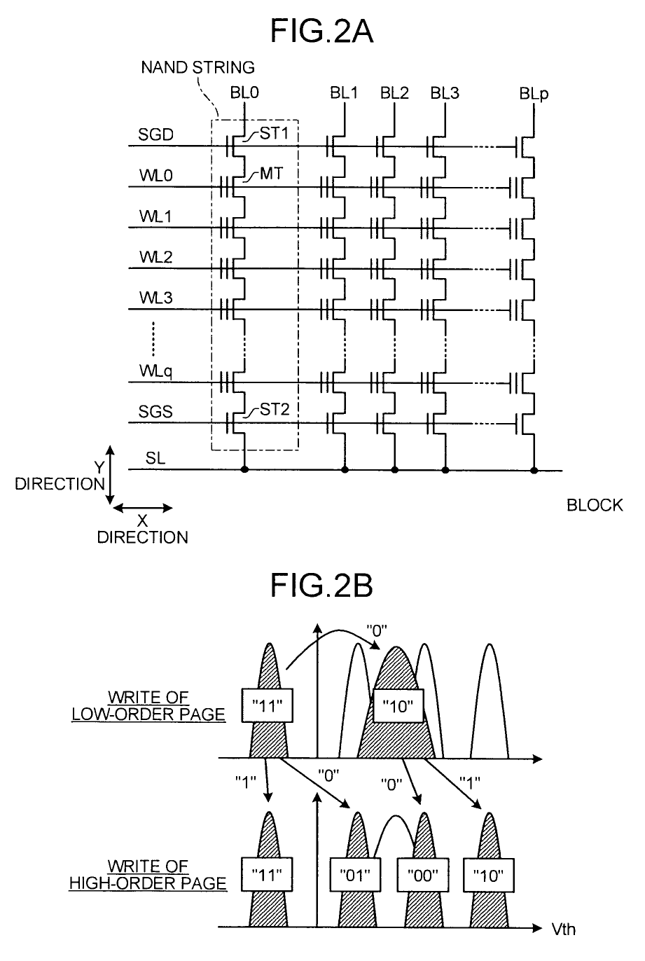

FIG. 2A is a configuration example of a physical block of the NAND memory 2. Each block includes (m+1) NAND strings arrayed sequentially in an X direction (m is an integer equal to or larger than 0). In a selection transistor ST1 respectively included in the (m+1) NAND strings, a drain is connected to bit lines BL0 to BLm, and a gate is commonly connected to a selection gate line SGD. In a selection transistor ST2, a source is commonly connected to a source line SL, and a gate is commonly connected to a selection gate line SGS.

Each memory cell transistor MT includes a metal oxide semiconductor field effect transistor (MOSFET) having a laminate gate structure formed on a semiconductor substrate. The laminate gate structure includes a charge accumulation layer (floating gate electrode) formed on the semiconductor substrate via a gate insulating film and a control gate electrode formed on the charge accumulation layer via an inter-gate insulating film. In the memory cell transistor MT, a threshold voltage changes according to the number of electrons accumulated in the floating gate electrode, and the memory cell transistor MT stores data according to a difference in the threshold voltage.

The memory cell transistor MT can be configured to store one bit or multiple values (data of two or more bits).

In each NAND string, (n+l) memory cell transistors MT are arranged between the source of the selection transistor ST1 and the drain of the selection transistor ST2 so that respective current pathways are serially connected. That is, a plurality of memory cell transistors MT is serially connected in a Y direction in such a form that adjacent memory cell transistors share a diffusion region (source region or drain region). A control gate electrode is respectively connected to word lines WL0 to WLn sequentially from the memory cell transistor MT positioned closest to the drain side. Therefore, the drain of the memory cell transistor MT connected to the word line WL0 is connected to the source of the selection transistor ST1, and the source of the memory cell transistor MT connected to the word line WLn is connected to the drain of the selection transistor ST2.

The word lines WL0 to WLn commonly connect the control gate electrodes of the memory cell transistors MT between the NAND strings in the block. That is, the control gate electrodes of the memory cell transistors MT in the same row in the block are connected to the same word line WL. The (m+l) memory cell transistors MT connected to the same word line WL are handled as a page, and read/write is performed for each page.

Bit lines BL0 to BLm commonly connect the drains of the selection transistors ST1 between blocks. That is, the NAND strings in the same line in a plurality of blocks are connected to the same bit line BL.

Further, the memory cell transistor MT can have not only a configuration having the floating gate electrode but also a configuration capable of adjusting a threshold by trapping an electron on a nitride film interface as the charge accumulation layer, such as a metal-oxide-nitride-oxide-silicon (MONOS) transistor. The memory cell transistor MT having an MONOS structure can be configured to store one bit or multiple values (data of two or more bits) in the same manner.

FIG. 2B is an example of threshold distribution in a quaternary data storage system that stores 2 bits in a memory cell transistor MT.

In the quaternary data storage system, either one of quaternary data “xy” defined by high-order page data “x” and low-order page data “y” can be held in the memory cell transistor MT.

In the quaternary data “xy”, for example, data “11”, “01”, “00”, and “10” are allocated in order of threshold voltage of the memory cell transistor MT. In data “11”, the threshold voltage of the memory cell transistor MT is in a negative erased state.

In a write operation of a low-order page, data “10” is selectively written into the memory cell transistor MT for data “11” (in the erased state) by write of low-order bit data “y”.

Threshold distribution of data “10” before write of the high-order page is positioned in the middle of threshold distribution of data “01” and data “00” after write of the high-order page, and can be broader than threshold distribution after write of the high-order page.

In the write operation of the high-order page, write of high-order bit data “x” is performed selectively to a memory cell for data “11” and a memory cell for data “10”, and data “01” and data “00” are written therein.

Referring back to FIG. 1, the MPU 40 can perform data erasure at the same time for four channels by collecting a plurality of physical blocks from respective parallel operation elements 2a to 2d in the NAND memory 2 to form a logical block, and can allocate a storage area in a unit of logical block. The logical block is constituted, for example, by selecting a physical block belonging to the same bank one each from each channel (ch0 to ch3). In the case of 4-channel configuration, a logical block includes four physical blocks. Further, four physical pages in each physical block constituting the logical block can be designated as a set to constitute a logical page, to perform write and read at the same time for four channels.

A size of data that can be written into a bank at a time is predetermined, and hereinafter, this size is referred to as a unit write size. The unit write size has a value equal to a page (physical page) size in the first embodiment. Connection between the respective parallel operation elements 2a to 2d and the NAND controller 20 will be explained later in detail. An example of a nonvolatile semiconductor memory device having a plurality of independent buses to the NAND memory and enabling independent event processing with respect to each flash memory chip is disclosed in Japanese Patent Application Laid-Open No. H10-187359 filed by the same applicant.

When the data stored in the RAM 3 is read and written into the NAND memory 2, the MPU 40 issues a write request for transferring data from the RAM 3 to the NAND memory 2 to the NAND controller 20. The NAND controller 20 reads transfer data in each unit write size from the RAM 3 based on the write request, and sequentially transfers the read transfer data in each unit write size to the NAND memory 2. Each bank of the parallel operation elements as a write destination (transfer destination) in the NAND memory 2 writes the transfer data therein.

Each bank cannot receive the next transfer data while data write is being executed. Further, the NAND controller 20 cannot transfer a plurality of transfer data simultaneously via one channel. Therefore, the SSD according to the first embodiment has a function of performing the bank interleaving with respect to the data write operation. The bank interleaving with respect to the data write operation is specifically explained below.

First, when a plurality of pieces of transfer data are to be written into a certain parallel operation element, the MPU 40 allocates a write destination bank for each transfer data so that the write destinations of the transfer data are uniformly distributed to a plurality of banks included in the parallel operation element. For example, when 12 pieces of transfer data are written into the parallel operation element 2a, the banks 0 to 3 of the parallel operation element 2a become the write destination of 3 pieces of transfer data, respectively. When a logical address (logical block addressing: LBA) specified by the host device is associated with a bank, the MPU 40 selects pieces of transfer data that can be bank interleaved, to improve transfer efficiency.

The NAND controller 20 reads 12 pieces of transfer data from the RAM 3 and transfers 3 pieces of transfer data, respectively, to the banks 0 to 3 one by one sequentially. At this time, the NAND controller 20 selects a bank which is not performing the data write operation, after a piece of transfer data has been transferred, and performs the transfer operation of another piece of transfer data, for which the selected bank is designated as a write destination. In other words, the NAND controller 20 switches (changes) the bank as the write destination (transfer destination) every time a piece of data has been transferred. When there is no bank which is not performing the data write operation, the NAND controller 20 waits until any one bank finishes the data write operation.

By performing the bank interleaving with respect to the write operation, the time since the transfer operation of the transfer data was performed by the NAND controller 20 until the next transfer operation is performed can be reduced, and as a result, the transfer efficiency is improved as compared to a case that the bank interleaving is not performed. The NAND controller 20 is configured such that the bank interleaving is performed with respect to the data write operation independently, for the banks 0 to 3 included in the respective parallel operation elements 2b to 2d, which operate at the same time with the parallel operation element 2a. When the physical blocks belonging to the same bank are selected one each from the respective channels (ch0 to ch3) to form the logical block, parallel access is performed with respect to the banks of the same number included in the respective parallel operation elements 2a to 2d.

A method of selecting a transfer destination bank at the time of performing a bank interleaving operation is explained next. In the following explanations, a state in which the data write operation is being performed is expressed as a busy state, and a state in which the data write operation is not being performed is expressed as a ready state.

As a method compared with the first embodiment, there is a method of setting a priority level to the banks 0 to 3, and fixing the priority level from a level with high priority, for example, bank 0→bank 1→bank 2→bank 3. This method is referred to as a method of a comparative example. That is, according to the method of the comparative example, after a piece of transfer data has been transferred to a certain bank, the NAND controller 20 selects a bank from the banks in a ready state based on the fixed priority level to switch the transfer destination bank to the selected bank.

The time required for data write is different for each bank. Due to this difference, a blank time can occur after completion of the data write operation until the next transfer data is transferred. If the blank time occurs disproportionately in a specific bank, transfer efficiency as a whole can be degraded. According to the method of the comparative example, a deviation of the blank time cannot be prevented. On the other hand, the first embodiment has a main characteristic in that it is prevented that the blank time occurs disproportionately in a specific bank by sequentially updating the priority level so that priority becomes higher in an old bank with the longer elapsed time since execution of the last data transfer. A difference in the operation between the method of the comparative example and the method of the first embodiment is schematically explained below by way of examples.

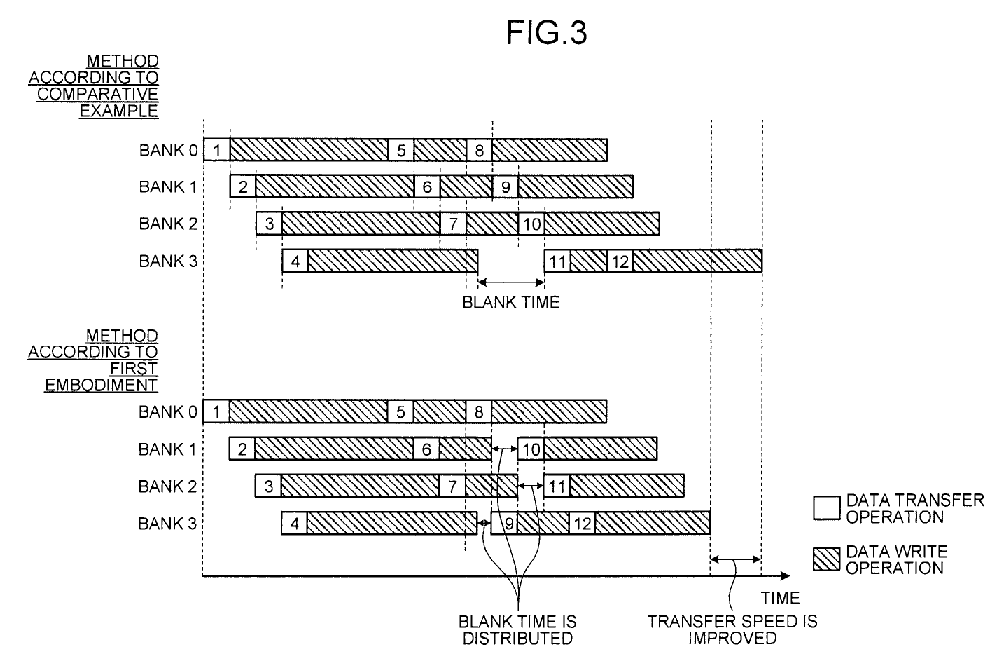

FIG. 3 is a schematic diagram for explaining an operation history of respective banks 0 to 3 when bank switching is performed according to the method of the comparative example and the method of the first embodiment, at the time of writing three pieces of transfer data to each of the banks 0 to 3. The elapsed time is plotted on an X axis in FIG. 3. An open rectangular pattern with numeral indicates an execution history of data transfer in each unit write size from the NAND controller 20 to each bank, and the numeral added to the rectangular pattern indicates a sequence of data transfer determined based on the priority level. A hatched rectangular pattern indicates an execution history of the data write operation in each unit write size, transferred to each bank.

As shown in the upper part of FIG. 3, according to the method of the comparative example, first data is transferred to the bank 0 as the transfer destination (data transfer 1). Thereafter, data transfer 2, 3, 4, 5, 6, and 7 are performed by designating the banks 1, 2, 3, 0, 1, and 2 as the transfer destination, respectively, according to the priority level fixed in order of banks 0, 1, 2, and 3 from higher priority level. It is assumed that when data transfer 7 has finished, in the bank 3, write of data transferred by data transfer 4 is prolonged, and the bank 3 is still in a busy state. At a point in time when data transfer 7 has finished, the bank 0, which is in a ready state, is selected as the transfer destination for the next data transfer 8. At a point in time when data transfer 8 has finished, the bank 1 and the bank 3 are in a ready state. However, according to the fixed priority level, the bank 1 selected as the next transfer destination. Thereafter, data transfers 10 and 11 are performed with respect to the banks 2 and 3, and lastly, data transfer 12 is performed with respect to the bank 3.

As the operation history of the bank 3 is focused on, a longer blank time has occurred since completion of write of transfer data by data transfer 4 until the next data transfer 11 is started. Due to the blank time, the time required for transfer and write of 3 pieces of data in the bank 3 becomes prominently long as compared to other banks. As a result, it is understood that the time required since start of transfer of 12 pieces of data in total until write of all pieces of data finishes becomes long.

According to the method of the first embodiment shown in the lower part of FIG. 3, the priority level in an initial state is banks 0, 1, 2, 3, and the priority level is sequentially updated so that the priority (selection priority) becomes higher in the old bank with the longest elapsed time since execution of the last data transfer. As a result, the operation history up to data transfer 8 becomes the same as in the method of the comparative example. At a point in time when data transfer 8 has finished, the last data transfer time is in order of banks 3, 1, 2, and 0 from the oldest. That is, not the bank 1 but the bank 3 is selected as the transfer destination for data transfer 9. At a point in time when data transfer 9 has finished, because the last data transfer time is in order of banks 1, 2, 0, and 3 from the oldest, the bank 1 is selected as the transfer destination for data transfer 10. Thereafter, data transfers 11 and 12 are performed according to the same operation.

According to the operation history by the method of the first embodiment, the blank time occurred in the bank 3 in the example of the operation history in the method of the comparative example is distributed to the banks 1 to 3. As a result, it is understood that the total transfer time required until write of all 12 pieces of data finishes is reduced as compared to the method of the comparative example, and transfer speed is improved. That is, when the method of the first embodiment is adopted, the transfer efficiency is improved as compared to a case of adopting the method of the comparative example.

Generally, write into a low-order page is performed at a higher speed than the write into a high-order page. The write of the transfer data transferred by data transfers 5, 6, 7, and 11 in the method of the comparative example shown in the upper part of FIG. 3 (corresponding to the transfer data transferred by data transfers 5, 6, 7, and 9 in the method of the first embodiment shown in the lower part of FIG. 3) corresponds to, for example, the write into the low-order page. The write of the transfer data transferred by data transfers 1, 2, 3, 4, 8, 9, 10, and 12 (corresponding to the transfer data transferred by data transfers 1, 2, 3, 4, 8, 10, 11, and 12 in the method of the first embodiment shown in the lower part of FIG. 3) corresponds to, for example, the write to the high-order page.

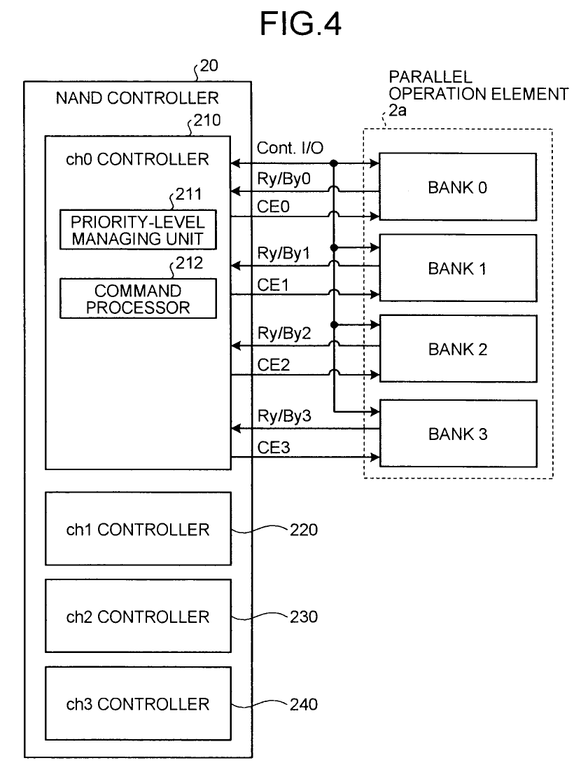

FIG. 4 is a schematic diagram for explaining a functional configuration included in the NAND controller 20 and a relation of connection between the NAND memory 2 and the NAND controller 20 for realizing the characteristic of the first embodiment schematically explained above. As shown in FIG. 4, the NAND controller 20 includes four controllers (a ch0 controller 210, a ch1 controller 220, a ch2 controller 230, and a ch3 controller 240) as memory controllers that respectively control data transfer to the parallel operation elements 2a to 2d. Because the ch0 controller 210, the ch1 controller 220, the ch2 controller 230, and the ch3 controller 240 have the same function, only the ch0 controller 210 is explained below as a representative. In FIG. 4, only the parallel operation element 2a in which the data transfer is controlled by the ch0 controller 210 is shown.

The banks 0 to 3 of the parallel operation element 2a is individually connected to the ch0 controller 210, respectively, via ready/busy (Ry/By) signal lines (Ry/By0 to Ry/By3). The banks 0 to 3 individually notify the ch0 controller 210 via the Ry/By signal lines, respectively, of whether the bank itself is in a busy state or ready state. As an example, it is assumed that Ry/By=L indicates a busy state and Ry/By=H indicates a ready state. The banks 0 to 3 are individually connected to the ch0 controller 210, respectively, via chip enable (CE) signal lines (CE0 to CE3) for selecting a chip. When the respective banks have a plurality of memory chips, the Ry/By signal lines and the CE signal lines of the respective memory chips are commonly connected.

One end of a Cont. I/O signal line for transferring a command, address, and data is connected to the ch0 controller 210. The other end of the Cont. I/O signal line is branched to four, and the branched four Cont. I/O signal lines are respectively connected to the banks 0 to 3. The ch0 controller 210 transmits a write command including a data write command, an address of write destination, and transfer data in the unit write size read from the RAM 3 one each to the four banks 0 to 3 via the Cont. I/O signal line. Because the NAND memory 2 side of the Cont. I/O signal line is branched to four and connected to the banks 0 to 3, the banks 0 to 3 receive the same write command simultaneously. However, the respective banks 0 to 3 determine whether to execute the write command based on the level of the CE signal line.

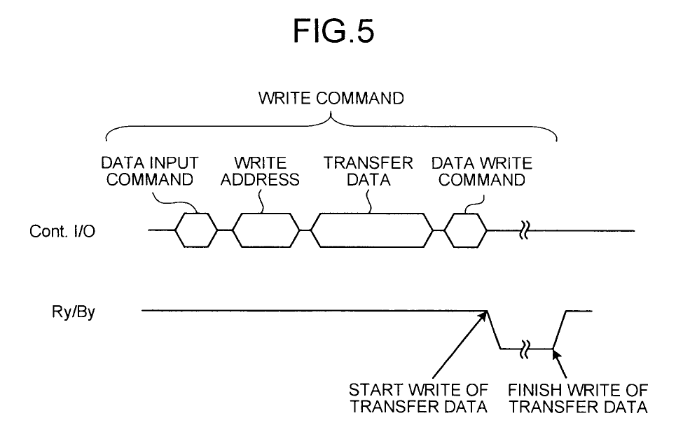

FIG. 5 is a timing chart indicating the state of the Cont. I/O signal line when a write command in which a certain bank (bank i (i=0 to 3)) is designated as a transfer destination is issued and a write operation is performed, and the state of the Ry/By signal line for connecting a transfer destination bank i and the ch0 controller 210. As shown in FIG. 5, a write command including a data input command, write address, transfer data, and a data write command is transmitted from the ch0 controller 210 via the Cont. I/O signal line, the bank i having received the write command starts write of transfer data to set Ry/By=L, and when the write is complete, the bank i sets Ry/By=H.

More specifically, the respective memory chips constituting the bank i include a primary buffer (data cache) that temporarily stores the transmitted transfer data and a secondary buffer (page buffer) intervening between the data cache and a memory cell array.

The ch0 controller 210 transfers the transfer data in the unit write size (page size) included in the write command to the data cache. Upon reception of the data write command following the transfer data, the respective memory chips constituting the bank i set Ry/By=L and transfer the transfer data stored in the data cache to the page buffer.

The respective memory chips constituting the bank i program the transfer data transferred to the page buffer into the write address in the memory cell array, which is a storage area. Further, the respective memory chips constituting the bank i read the programmed data from the memory cell array and compare the read data with the transfer data held in the page buffer, to verify whether the transfer data is correctly programmed in the memory cell array (Program and Verify).

As a result of comparison and verification, when the both data match each other, the respective memory chips constituting the bank i recognize that the transfer data has been correctly programmed in the memory array cell, set Ry/By=H, and finish the write operation involved with the received write command. As a result of comparison and verification, when the both data do not match each other, the respective memory chips constituting the bank i attempt to program the transfer data held in the page buffer in the memory cell array until the both data match each other as the result of comparison and verification. The number of attempts is set to a desired value beforehand.

Thus, because the write operation of the transfer data in the respective memory chips constituting the bank i includes transfer of the transfer data from the data cache to the page buffer, programming of the transfer data in the memory cell array, and read and verification of the programmed data, a longer time is required as compared to the data transfer operation from the ch0 controller 210 to the bank i.

In this example, the write command includes the data input command, write address, transfer data, and data write command. However, the write command can transmit different information in addition to these pieces of information.

Referring back to FIG. 4, the ch0 controller 210 further includes a priority-level managing unit 211 and a command processor 212 that transmits the write command to the banks 0 to 3 of the parallel operation element 2a. The priority-level managing unit 211 updates and manages the priority level of the transfer destination bank every time the write command is transmitted. Specifically, the priority-level managing unit 211 manages identification numbers of the banks (bank numbers, and in this case, 0 to 3) in an array arranged from a top in a descending order of priority. For example, the priority-level managing unit 211 can include a storage area therein such as a register or small memory so that the array of priority level is held therein, or held in other storage areas. When transmission of the write command is executed last, the priority-level managing unit 211 shifts the priority of the transfer destination bank in the write command to the lowest level, thereby sequentially updating such that a bank number with the longest elapsed time since execution of the last data transfer is brought closest to the top of the array. It is assumed that the bank numbers are arranged from the top in the descending order of priority; however, the bank numbers can be arranged from the top in an ascending order of priority.

The command processor 212 reads the transfer data from the RAM 3 based on the write request received from the MPU 40, to generate a write command. For example, the command processor 212 can include a storage area therein such as a register or small memory so that the generated write command is held therein, or held in other storage areas. The command processor 212 selects a data transfer destination bank (a bank as a target of the write command) based on the states of the banks 0 to 3 notified via the Ry/By signal lines and the priority level managed by the priority-level managing unit 211, and transmits the write command in which the selected bank is set as a write destination to the banks 0 to 3 via the Cont. I/O signal line.

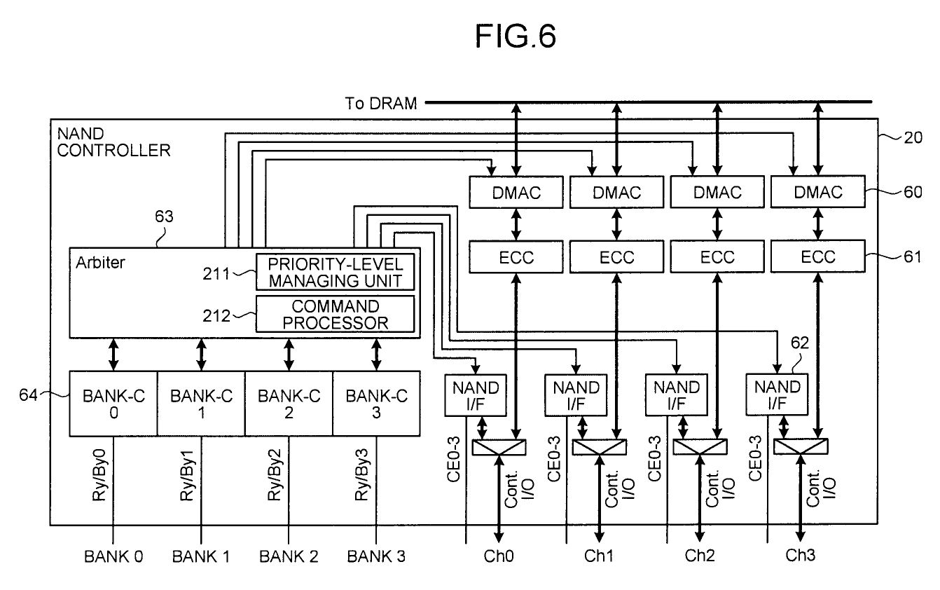

While it is explained that the Ry/By signal line for each bank of the parallel operation element 2a is connected to the ch0 controller 210, the Ry/By signal line for each bank can be commonly connected between the parallel operation elements 2a to 2d and input to the NAND controller 20. A specific configuration example of the NAND controller 20, taking into consideration parallel operations between channels when the Ry/By signal lines for respective banks are commonly connected is explained with reference to FIG. 6.

FIG. 6 is a specific configuration example of the NAND controller 20, taking into consideration the parallel operations between channels when the Ry/By signal lines for respective banks are commonly connected.

The NAND controller 20 includes a DMA controller (DMAC) 60, an error correction circuit (ECC) 61, and a NAND I/F 62 so that each parallel operation element is independently operated. Each NAND I/F 62 is connected with CE signal lines for four banks (CE0 to CE3), to control the CE signal lines (CE0 to CE3) according to the bank to be accessed.

The NAND controller 20 further includes an arbiter 63 that arbitrates a right of use of the channel, and four bank controllers (BANK-C) 64 that monitor the Ry/By signal lines commonly connected between the parallel operation elements 2a to 2d for each bank and manage the state of the bank. In the first embodiment, because four banks share one channel, when a plurality of access requests is overlapped, the arbiter 63 arbitrates the right of use of the channel to use the channel in a time-sharing manner.

A correspondence relation between the ch0 controller 210 and the configuration example shown in FIG. 6 is explained. The priority-level managing unit 211 and the command processor 212 are placed in the arbiter 63. The priority-level managing unit 211 and the command processor 212 placed in the arbiter 63, one of the DMACs 60, ECCs 61, and NAND I/Fs 62 corresponding to ch0 incorporated in each channel, and the BANK-C 64 cooperate and function as the ch0 controller 210.

The write command generated by the command processor 212 placed in the arbiter 63 is queued to one of the four BANK-Cs 64 corresponding to the write destination bank. The command processor 212 receives Ry/By=H from the four BANK-Cs 64 based on the array managed by the priority-level managing unit 211, reads the write command from the BANK-C that manages the bank with the highest priority, and transmits the read write command to the parallel operation element 2a via the NAND I/F 62.

The priority-level managing unit and the command processor respectively included in the ch1 controller 220 to ch3 controller 240 are placed in the arbiter 63 in the same manner, and integrated with the priority-level managing unit 211 and the command processor 212. The priority-level managing unit 211 and the command processor 212, one of the DMACs 60, ECCs 61, and NAND I/Fs 62 of the corresponding ch, and the BANK-C 64 cooperate and function as the ch1 controller 220 to ch3 controller 240, respectively.

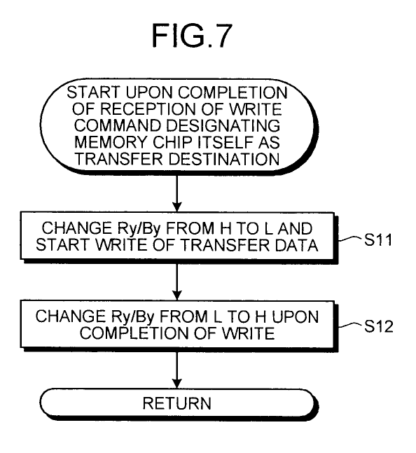

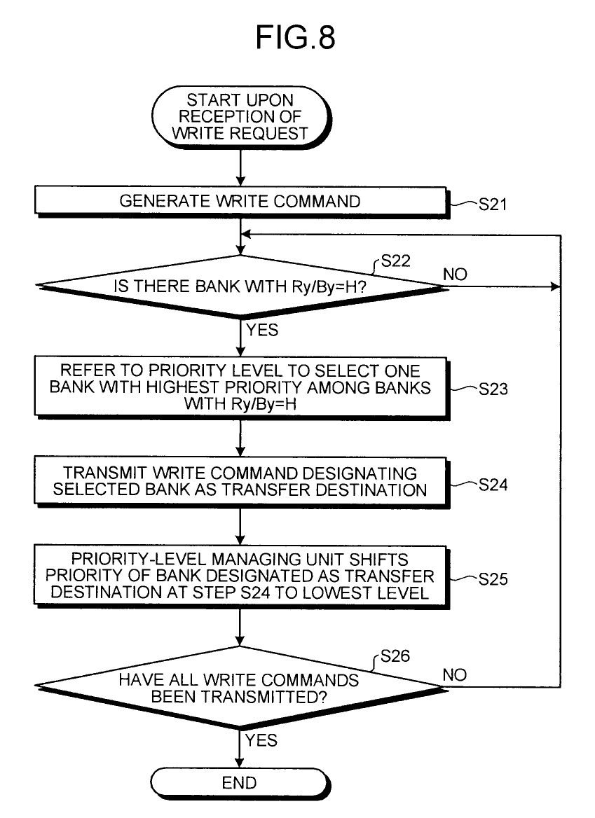

An operation of transferring data from the NAND controller 20 to the NAND memory 2 in the SSD according to the first embodiment configured as described above is explained next with reference to FIGS. 7 and 8.

FIG. 7 is a flowchart for explaining the operation of the bank of the parallel operation element 2a. As shown in FIG. 7, upon completion of reception of a write command designating the memory chip itself as a transfer destination, the memory chip constituting the bank changes the state of the Ry/By signal line for connecting the memory chip itself to the ch0 controller 210 from H to L, to start write of transfer data included in the write command (Step S11). Upon completion of write of the transfer data, the bank changes the state of the Ry/By signal line from L to H (Step S12), and returns to Step S11.

FIG. 8 is a flowchart for explaining the operation of the ch0 controller 210. As shown in FIG. 8, upon reception of a write request for transferring data from the MPU 40 to the parallel operation element 2a, the command processor 212 generates a plurality of write commands in each unit write size, respectively designating the banks 0 to 3 as write destinations based on the write request (Step S21). The command processor 212 searches for a bank with Ry/By=H (Step S22), and if there is no bank with Ry/By=H (NO at Step S22), search is continued until a bank with Ry/By=H is found.

When there is a bank with Ry/By=H (YES at Step S22), the command processor 212 refers to the array managed by the priority-level managing unit 211 from the top, to select a bank with the highest priority among the banks with Ry/By=H (Step S23). When there is only a bank with Ry/By=H, the command processor 212 selects this bank. Following Step S23, the command processor 212 selects a write command designating the selected bank as a write destination from the generated write commands, and transmits the write command to the banks C to 3 of the parallel operation element 2a (Step S24).

When transmission of the write command is started at Step S24, the priority-level managing unit 211 shifts the number of the bank, which executes the transmitted write command, that is, the number of the bank selected at Step S24 to the last of the array of priority level, so that a position of a bank number in the back of the array than the bank number before the shift is brought forward toward the top of the array one by one (Step S25). It is assumed that the array of priority level is updated when transmission of the write command is started. However, update can be performed immediately after the write command is transmitted, or during the write command is being transmitted. Accordingly, when the command processor 212 proceeds to Step S23 next time, the priority of the bank selected this time at Step S23 is the lowest.

The command processor 212 determines whether all the generated write commands have been transmitted (Step S26), and when there is an untransmitted write command (NO at Step S26), the command processor 212 proceeds to Step S22. When all the write commands have been transmitted (YES at Step S26), the operation finishes.

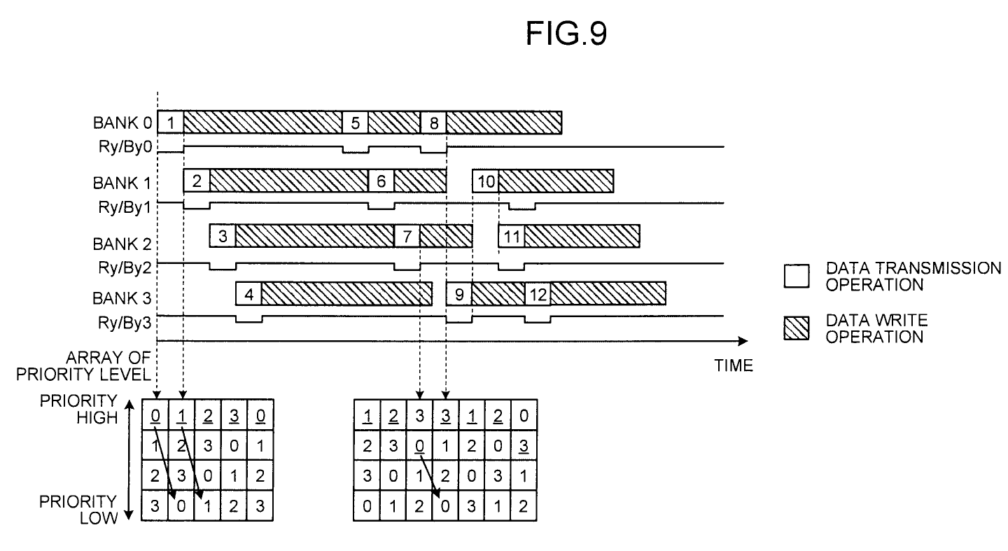

In this manner, a bank with the longest elapsed time since the last execution of the data transfer is preferentially selected as the transfer destination bank. FIG. 9 is an example of an operation history according to the first embodiment shown in the lower part of FIG. 3, added with the state of the Ry/By signal line of the respective banks 0 to 3 and an array of priority level updated every second. An open rectangular pattern (history of the data transfer operation) shown in FIG. 9 (and FIG. 3) is used in the sense of a history of operation for transmitting the write command. Because the priority level is arranged in the descending order such as banks 0, 1, 2, 3, the bank 0 is selected as a transfer destination of data transfer 1 performed first. After transfer of the write command has been started, the level of the bank 0 is shifted to the lowest, that is, bank number 0 is shifted to the last of the array, so that the priority level is changed to banks 1, 2, 3, 0. The number added with underline in the array of priority level indicates a bank number selected as a transfer destination for the next data transfer. At a point in time when data transfer 7 is finished, the priority level is banks 3, 0, 1, 2, and the bank 0 with the Ry/By signal line being H is selected as the transfer destination, and the priority level changes to banks 3, 1, 2, 0. As the transfer destination of data transfer 9, the bank 3 with the highest priority is selected from the banks 1 and 3, in which the Ry/By signal line is H at a point in time when data transfer 8 is finished.

As described above, according to the first embodiment, the ch0 controller 210 selects a bank with the highest selection priority from the banks in a ready state included in the parallel operation element 2a, after transmission of the write command, changes the selected bank as a target of the next write command, and shifts the level of selection priority of the selected bank at the time of next selection of the bank to the lowest level. Therefore, the blank time occurring in the individual operation history in each bank is distributed to a plurality of banks, thereby enabling to perform an efficient bank interleaving operation. Further, because the selection priority of the banks is managed in an array of the bank number, a bank with the longest elapsed time since last transmission of an operation command is preferentially selected, without mounting a complicated mechanism that records a transmission time of the operation command and compares the transmission time with each other.

A case that the bank interleaving is performed with respect to the data write operation has been explained above. However, the method of the first embodiment can be applied to cases other than the case of performing data write, so long as the operation enables bank interleaving. For example, when the bank interleaving is performed with respect to a data read operation, after a read command including a read command and a read source address is transmitted, a bank as a data read source is changed based on the Ry/By signal line and the level of selection priority, and the level of selection priority at the time of next selection of the bank to be changed can be shifted to the lowest level. When the bank interleaving is performed with respect to a data erasure operation, after a data erasure command including a data erasure command and an address of data to be erased is transmitted, a bank as a target of the data erasure command is changed based on the Ry/By signal line and the level of selection priority, and the level of selection priority at the time of next selection of the bank to be changed can be shifted to the lowest level. At this time, each bank is set to output Ry/By=L (busy state) when not only the data write operation but also the data read operation and the data erasure operation are being performed, and output Ry/By=H (ready state) when the data write operation, the data read operation, and the data erasure operation are not being performed. Further, each bank can output Ry/By=L when the bank is in a ready state, and Ry/By=H when the bank is in a busy state.

A case that the bank interleaving is performed in the same kind of operation (here, data write) between the banks has been explained above. However, the method of the first embodiment can be applied to a case that the bank interleaving is performed with respect to different kinds of operation (data write, data read, and data erasure) between the banks. That is, a bank as a target of the operation command (write command, read command, and data erasure command) (a transfer destination bank, a read source bank, and a bank as a target of the data erasure command) is changed based on the Ry/By signal line and the level of selection priority, and the level of selection priority at the time of next selection of the bank as a target of the command can be shifted to the lowest level.

Further, while it has been explained that the four parallel operation elements are included and each parallel operation element is divided into four banks, the number of parallel operation elements and the number of banks in each parallel operation element are not limited to these numbers.

Recently, a technique in which an inside of each memory chip constituting each bank is divided into a plurality of planes having a peripheral circuit (row decoder, column decoder, or the like) individually, and the planes are caused to perform different memory operations, respectively, by a memory operation command, thereby realizing high-speed memory access has been developed. An example of a nonvolatile semiconductor memory device having a plurality of planes is disclosed in U.S. Patent Application Publication No. 2007/0206419. According to this technique, each plane individually includes a data cache and a page buffer.

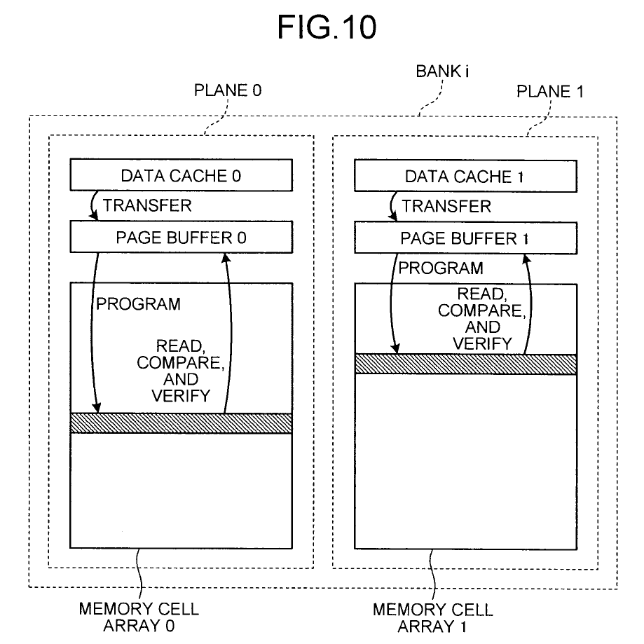

FIG. 10 is a schematic diagram for explaining a configuration example of respective memory chips constituting each bank (bank i). Each memory chip constituting the bank i is divided, as shown in FIG. 10, into a plurality of (here, two) planes (plane 0, plane 1), and the plane 0 includes a data cache 0, a page buffer 0, and a memory cell array 0, and plane 1 includes a data cache 1, a page buffer 1, and a memory cell array 1. The transfer data in a page size respectively transmitted from the NAND controller to the plane 0 and plane 1 is temporarily accumulated in the data cache 0 and data cache 1, respectively. The transfer data accumulated in the data cache 0 is programmed in the memory cell array 0 via the page buffer 0. The transfer data accumulated in the data cache 1 is programmed in the memory cell array 1 via the page buffer 1. The respective planes 0 and 1 can individually perform a write operation of the transfer data including transfer of the transfer data from the data caches 0 and 1 to the page buffers 0 and 1, programming of the transfer data transferred to the page buffers 0 and 1 in the memory cell arrays 0 and 1, read of the programmed data, and comparison and verification of the read data with the transfer data stored in the page buffers 0 and 1.

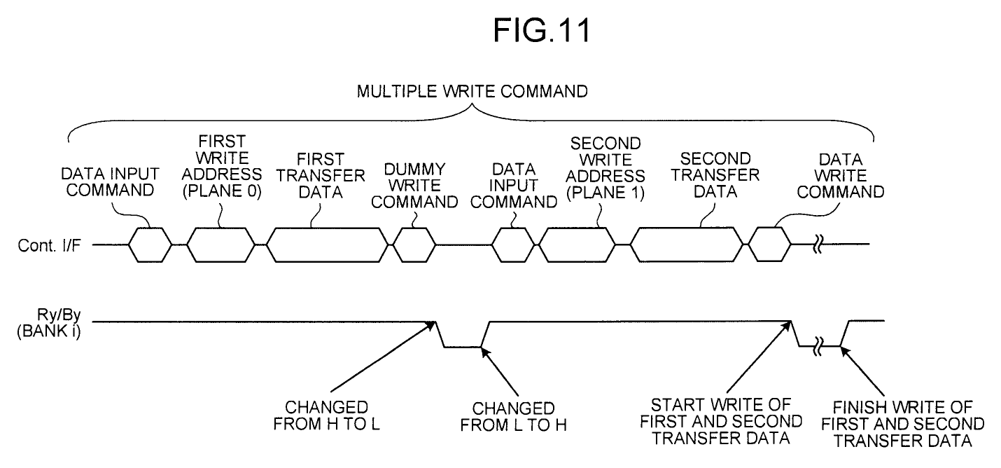

FIG. 11 is a timing chart for explaining an example of the state of the Cont. I/O signal line and the Ry/By signal line when a write command for writing different pieces of transfer data into a plurality of planes is transmitted and performed. Hereinafter, this write command is referred to as a multiple write command. In the explanations in FIG. 11 and thereafter, it is assumed that two pieces of transfer data in a page size are transferred to the respective banks constituted as shown in FIG. 10 by a multiple write command, and respectively written in the planes 0 and 1.

As shown in FIG. 11, a multiple write command includes a data input command, a first write address as an address of the plane 0 in the bank i, first transfer data to be written in the first write address, a dummy write command, a data input command, a second write address as an address of the plane 1 in the bank i, second transfer data to be written in the second write address, and a data write command. When having received the dummy write command, the bank i once sets Ry/By=L, and then sets Ry/By=H. When having received the data write command, the bank i simultaneously starts the write operation of the transfer data temporarily stored in the data caches 0 and 1, and sets Ry/By=L when the write operation is being performed in either plane, or sets Ry/By=H when the write operation is not being performed in any plane. The time required after the dummy write command is received and the state of the bank i is changed to Ry/By=L and then returned to Ry/By=H is shorter than the time during which the bank i is in the Ry/By=L state during execution of the write operation.

When the data input command, first write address, first transfer data, and dummy write command are transmitted to the Cont. I/O signal line, the bank i changes the state of the Ry/By signal line from H to L, and thereafter, changes the state of the Ry/By signal line from L to H. The bank i accumulates the transmitted first transfer data in the data cache 0. Upon detection of a change in the state of the Ry/By signal line from H to L, the ch0 controller starts an operation of transmitting the data input command, second write address as the address of the plane 1 of the bank i, second transfer data, and data write command to the Cont. I/O signal line. The bank i accumulates the transmitted second transfer data in the data cache 1. When the data write command is transmitted, the bank i simultaneously starts the write operation of the first transfer data accumulated in the data cache 0 and the write operation of the second transfer data accumulated in the data cache 1, and changes the state of the Ry/By signal line from H to L. Upon completion of the write operation in the plane 0 and plane 1, the bank i changes the state of the Ry/By signal line from L to H. Thus, because the data cache in a plurality of planes respectively accumulates the transfer data, and concurrently starts the write operation of the transfer data in the planes by a data write command, high-speed write can be realized as compared to the case that a write command (hereinafter, “single write command”) is transmitted continuously in a plurality of numbers explained in the first embodiment. Because the transfer data for two pages is written in the respective banks by a multiple write command, the size of two pages becomes the unit write size.

As focusing on the Ry/By signal line, it is understood that the state of the Ry/By signal line is changed from L to H, at times other than at the time of completion of a multiple write operation. Therefore, if the transfer destination is simply selected from the banks with the state of the Ry/By signal line being H as in the first embodiment, bank switching timing becomes between completion of the write operation of the first transfer data and start of reception of the second transfer data. If the transfer destination bank is selected at this timing, the second transfer data, which is to be transferred to the bank, cannot be transferred. To solve this problem, in a second embodiment of the present invention, it is configured such that the transfer destination bank is selected from the banks in which write of all pieces of transfer data has been complete based on the multiple write command.

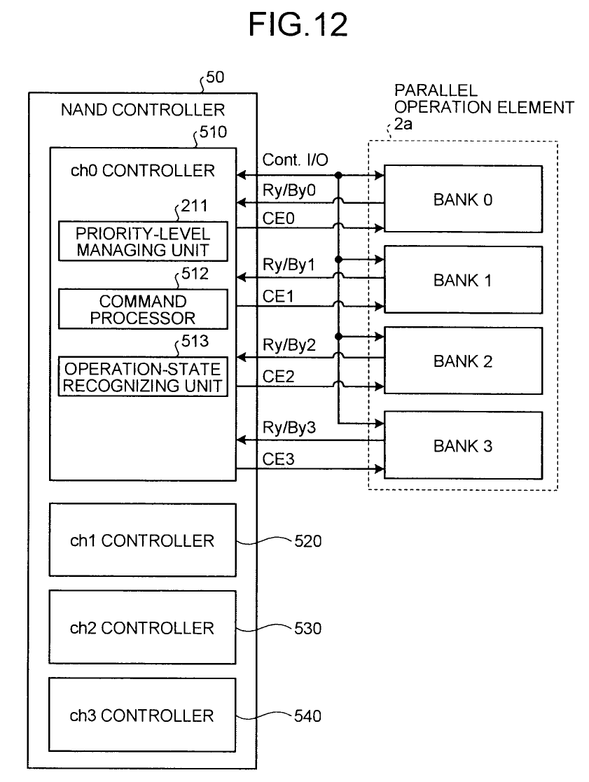

FIG. 12 is a schematic diagram for explaining a functional configuration of a NAND controller according to the second embodiment. The configuration other than a NAND controller 50 is the same as that of the first embodiment. However, the MPU 40 can transmit a multiple write request for causing the NAND controller 50 to perform a multiple write operation based on the firmware.

The NAND controller 50 includes four controllers (a ch0 controller 510, a ch1 controller 520, a ch2 controller 530, and a ch3 controller 540) as memory controllers that respectively control data transfer to the parallel operation elements 2a to 2d. Because the ch0 controller 510, the ch1 controller 520, the ch2 controller 530, and the ch3 controller 540 have the same function, only the ch0 controller 510 is explained below as a representative. In FIG. 12, only the parallel operation element 2a in which the data transfer is controlled by the ch0 controller 510 is shown.

A relation of connection between the parallel operation element 2a and the ch0 controller 510 is the same as the relation of connection between the parallel operation element 2a and the ch0 controller 210 according to the first embodiment. Therefore, detailed explanations thereof will be omitted.

The ch0 controller (memory controller) 510 further includes the priority-level managing unit 211, a command processor 512 that transmits the multiple write command to the banks 0 to 3 of the parallel operation element 2a, and an operation-state recognizing unit 513 that recognizes an operation state of the banks 0 to 3 of the parallel operation element 2a.

The priority-level managing unit 211 sequentially updates and manages the priority level of the banks 0 to 3, as in the first embodiment. The operation-state recognizing unit 513 recognizes the operation state of each bank, that is, whether the multiple write command transmitted from the command processor 512 is complete for each bank, based on the state of the Ry/By signal line. The command processor 512 selects a transfer destination bank of the transfer data based on the operation state of each bank recognized by the operation-state recognizing unit 513, and the priority level managed by the priority-level managing unit 211, and transmits a multiple write command to the selected bank.

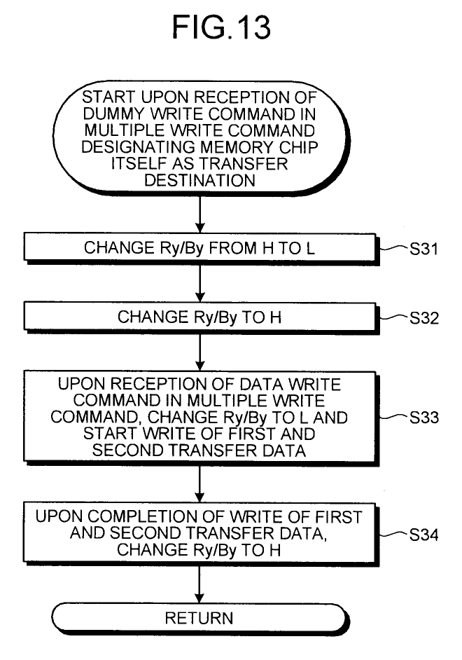

An operation for transferring data from the NAND controller 50 to the NAND memory 2 in the SSD according to the second embodiment is explained with reference to FIGS. 13, 14, and 15. FIG. 13 is a flowchart for explaining the operation of the banks 0 to 3 included in the parallel operation element 2a.

As shown in FIG. 13, a memory chip constituting a bank changes the state of the Ry/By signal line connecting the memory chip itself to the ch0 controller 510 from H to L, when reception of a multiple write command designating the memory chip itself as a transfer destination is started and reception of up to the dummy write command included in the multiple write command is complete (Step S31). Following Step S31, the bank changes the state of the Ry/By signal line from L to H (Step S32). Subsequently, upon reception of up to the data write command, the bank changes the state of the Ry/By signal line from H to L again, to start write of the first transfer data accumulated in the data cache 0 of the plane 0 and the second transfer data accumulated in the data cache 1 of the plane 1 (Step S33). Upon completion of the write in the planes 0 and 1, the bank changes the state of the Ry/By signal line from L to H (Step S34), and returns to Step S31.

The operation-state recognizing unit 513 monitors the state of the Ry/By signal line for the respective banks 0 to 3, to recognize whether the operation state is in a state of “executing the multiple write command” for each bank based on a change in the Ry/By signal line according to the dummy write command and a change in the Ry/By signal line at the time of completion of write in each plane. That is, upon detection of a fall from H to L at Step S34, the operation-state recognizing unit 513 recognizes the state of the bank, in which the fall from H to L has been detected, as the state of “executing the multiple write command”. Upon detection of a rise from L to H at Step S34, the operation-state recognizing unit 513 recognizes the state of the bank, in which the rise from L to H has been detected, as a state of “having executed the multiple write command”. The state of the bank in which the multiple write command designating the memory chip itself as the transfer destination has not been received, and the multiple write command has not been executed is not in the state of “executing the multiple write command” but substantially in the same state as the state of “having executed the multiple write command”. Therefore, it is explained here that the bank is in the state of “having executed the multiple write command” for descriptive purposes.

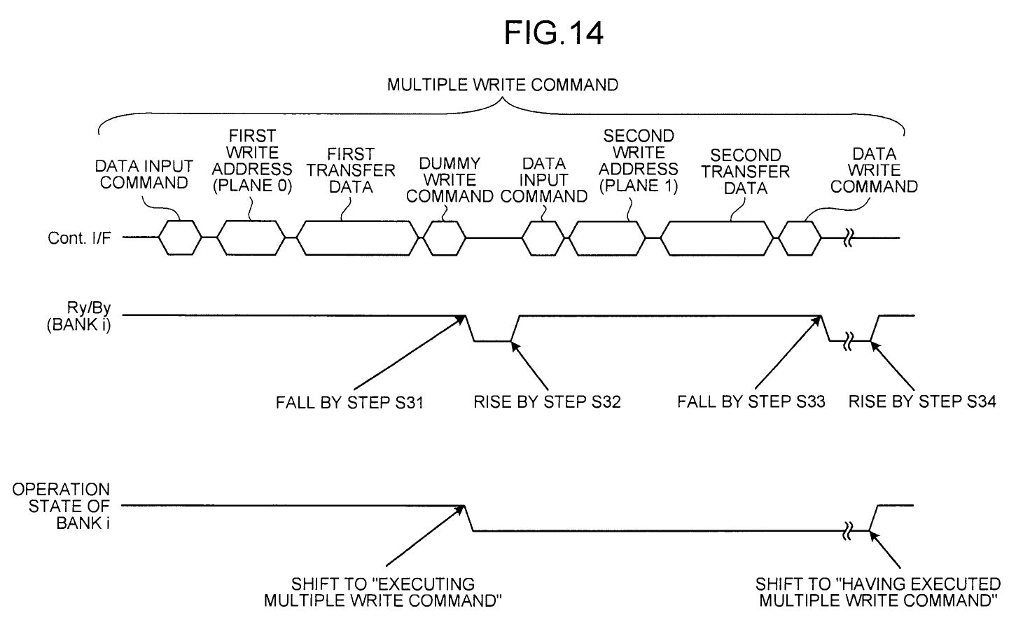

FIG. 14 is a timing chart for explaining a recognition operation by the operation-state recognizing unit 513. As shown in FIG. 14, when the Ry/By signal line indicates busy based on the dummy write command in the bank i, the operation-state recognizing unit 513 recognizes that the bank i is in the state of “executing the multiple write command”. When the write operation is complete in the planes 0 and 1 in the bank i, the operation-state recognizing unit 513 recognizes that the bank i is in the state of “having executed the multiple write command”. Accordingly, even when the bank i is in a ready state between reception of the first transfer data and reception of the second transfer data, the operation-state recognizing unit 513 recognizes that the bank i is in the state of “executing the multiple write command”.

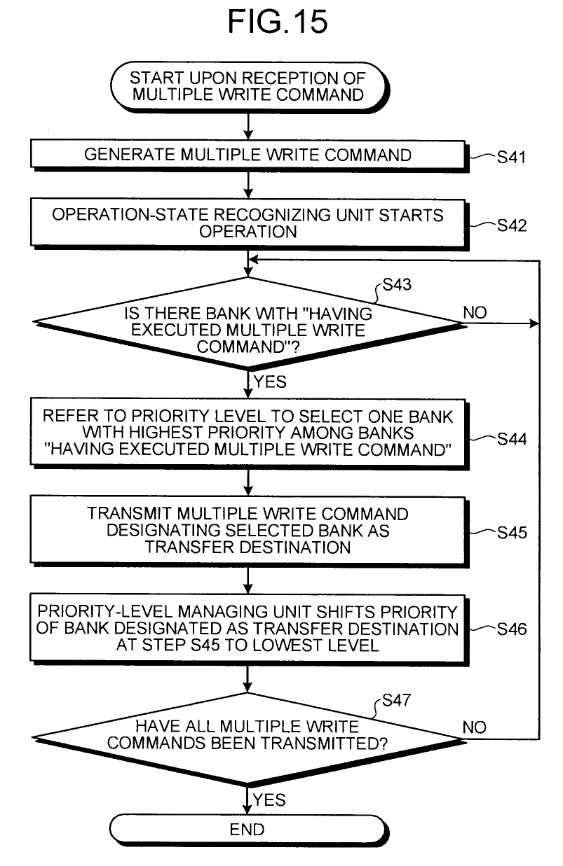

FIG. 15 is a flowchart for explaining an operation of the ch0 controller 510. As shown in FIG. 15, upon reception of a multiple write request for writing data with respect to the parallel operation element 2a, the ch0 controller 510 generates a multiple write command (Step S41). The operation-state recognizing unit 513 then starts the operation for recognizing the operation sate shown in FIG. 14 (Step S42).

The command processor 512 then refers to the operation-state recognizing unit 513, to search for a bank with the state being “having executed the multiple write command” (Step S43). When there is no bank with the state being “having executed the multiple write command” (NO at Step S43), the command processor 512 continues search until a bank with the state being “having executed the multiple write command” is found.

When there is a bank with the state being “having executed the multiple write command” (YES at Step S43), the command processor 512 refers to the array managed by the priority-level managing unit 211 from the top, to select a bank with the highest priority from the banks with the state being “having executed the multiple write command”. When there is only one bank with the state being “having executed the multiple write command”, the command processor 512 selects this bank. Following Step S44, the command processor 512 selects a multiple write command designating the selected bank as a write destination from the generated multiple write commands, and transmits the multiple write command to the banks 0 to 3 of the parallel operation element 2a (Step S45).

The priority-level managing unit 211 shifts the number of the bank designated as the transfer destination at Step S45 to the last of the array of priority level, so that a position of a bank number in the back of the array than the bank number before the shift is brought forward toward the top of the array one by one (Step S46).

The command processor 512 determines whether all the generated multiple write commands have been transmitted (Step S47). When there is an untransmitted write command (NO at Step S47), the command processor 512 proceeds to Step S43. When all of the generated multiple write commands have been transmitted (YES at Step S47), the command processor 512 finishes the operation.

As described above, according to the second embodiment, when the bank interleaving is performed with respect to the multiple write operation for performing write operation of a plurality of pieces of transfer data by one bank, it is recognized whether the multiple write command for performing the multiple write operation is being performed based on a change in the Ry/By signal line for each bank, and a bank with the highest selection priority is selected from the banks in which the multiple write operation is not being performed. The selected bank is changed to a target of the next multiple write command, and the level of selection priority of the selected bank at the time of next selection of the bank is shifted to the lowest level. Therefore, the bank interleaving can be performed efficiently even in the SSD capable of performing the bank interleaving with respect to the multiple write operation.

In the above explanations, while it has been assumed that one bank is divided into two planes and data is transferred to each of the planes by a multiple write command, the number of division of one bank is not limited to two. That is, it is also possible that each bank is divided into three planes and pieces of data of the same number as that of the plane dividing number are transferred by a multiple write command.

When the write request explained in the first embodiment (hereinafter, “single write request”) is received, the command processor of the second embodiment can be configured to perform the same operation as in the first embodiment. Specifically, the command processor of the second embodiment can be provided with a functional unit that determines whether a write request received from the MPU is the single write request or multiple write request, so that when the single write request is received, the operation explained in the first embodiment is performed, and when the multiple write request is received, the operation explained in the second embodiment is performed.

A case that bank interleaving is performed with respect to a data write operation has been explained in the second embodiment. However, the second embodiment can be also applied to a case that bank interleaving is performed with respect to a data read operation and a data erasure operation like in the first embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory system comprising:
a plurality of nonvolatile memory areas capable of operating individually; and
a memory controller connected to each of the memory areas individually via a ready/busy signal for interleaving an operation in the memory areas by changing a memory area as a target of an operation command, every time the operation command is transmitted, wherein
the memory controller includes a priority-level managing unit that manages a level of selection priority for each memory area, so that after transmission of an operation command, the memory controller selects a memory area with a highest level of selection priority from memory areas in a ready state, to change the selected memory area to a target of a next operation command, and shifts the level of selection priority of the selected memory area at a time of next selection to a lowest level by the priority-level managing unit.

2. The memory system according to claim 1, wherein the priority-level managing unit manages the level of selection priority, using an array of identification numbers of each memory area.

3. The memory system according to claim 1, wherein the operation in the memory area includes data write, data read, and data erasure, and the memory area changes a ready/busy signal connected to the memory area itself to a busy state while the operation is being performed, and to a ready state while the operation is not being performed.

4. The memory system according to claim 1, wherein each of the memory areas is a bank constituted by a plurality of NAND flash memories, to which a ready/busy signal is commonly connected.

5. The memory system according to claim 4, wherein
the operation command includes transfer data and a write command sequentially transmitted to a memory area as a target of the operation command,
each of the memory areas further includes a primary buffer that temporarily stores transfer data included in the operation command, a storage area which is a write destination of the transfer data, and a secondary buffer intervening between the primary buffer and the storage area, and wherein
the memory area as a target of the operation command changes a ready/busy signal connected to the memory area itself to a busy state, upon reception of the write command included in the received operation command following the transfer data included in a same operation command, transfers the transfer data stored in the primary buffer to the secondary buffer, writes the transfer data stored in the secondary buffer into the storage area, and changes the ready/busy signal to a ready state upon completion of the write.

6. The memory system according to claim 5, wherein the memory area as a target of the operation command compares the transfer data stored in the secondary buffer with the transfer data written into the storage area, and when both of the transfer data match each other, the memory area changes the ready/busy signal to a ready state, and when both of the transfer data do not match each other, the memory area writes the transfer data stored in the secondary buffer into the storage area again.

7. A memory system comprising:
a plurality of nonvolatile memory areas capable of operating individually; and
a memory controller connected to each of the memory areas individually via a ready/busy signal for interleaving an operation in the memory areas by changing a memory area as a target of an operation command, every time the operation command for performing a plurality of operations is transmitted, wherein
the memory controller includes a priority-level managing unit that manages a level of selection priority for each memory area, and an operation-state recognizing unit that recognizes whether the operation command is being performed based on the ready/busy signal, so that after transmission of the operation command, a memory area with a highest level of selection priority is selected from the memory areas, in which the operation command is not being performed, to change the selected memory area to a next memory area as a target of a next operation command, and shifts the level of selection priority of the selected memory area at a time of next selection to a lowest level by the priority-level managing unit.

8. The memory system according to claim 7, wherein the priority-level managing unit manages the level of selection priority, using an array of identification numbers of each memory area.

9. The memory system according to claim 7, wherein the operation in the memory area includes data write, data read, and data erasure, and the memory area changes a ready/busy signal connected to the memory area itself to a busy state while the operation is being performed, and to a ready state while the operation is not being performed.

10. The memory system according to claim 7, wherein each of the memory areas is a bank constituted by a plurality of NAND flash memories, to which a ready/busy signal is commonly connected.

11. The memory system according to claim 10, wherein the memory area includes n planes capable of performing a different operation respectively, and the operation command causes the n planes included in the memory area to execute a different operation respectively.

12. The memory system according to claim 11, wherein the operation command includes n pairs of transfer data and write command designating a different plane as a write destination respectively, and sequentially transmitted to a memory area as a target of the operation command,
each of the planes included in the memory area further includes a primary buffer that temporarily stores transfer data designating the plane itself as a write destination and included in the operation command, a storage area which is a write destination of the transfer data, and a secondary buffer intervening between the primary buffer and the storage area,
the memory area as a target of the operation command changes a ready/busy signal connected to the memory area itself to a busy state only for a predetermined time, upon reception of the write command included in the operation command, changes the ready/busy signal to a busy state upon reception of a last write command of the write commands included in the operation command, transfers the transfer data stored in the primary buffer of each of the plane to the secondary buffer of each of the plane, writes the transfer data stored in the secondary buffer into the storage area of each of the plane, and changes the ready/busy signal to a ready state upon completion of the write in each of the plane.

13. The memory system according to claim 12, wherein the memory area as a target of the operation command compares the transfer data stored in the secondary buffer with the transfer data written into the storage area for each plane, and when both of the transfer data match each other in all the planes included in the memory area itself, the memory area changes the ready/busy signal to a ready state, and when there is a plane in which both of the transfer data do not match each other, the memory area writes the transfer data stored in the secondary buffer of the plane into the storage area again.

14. The memory system according to claim 12, wherein after transmission of the operation command to the memory area as a target of the operation command, the operation-state recognizing unit recognizes that the memory area as a target of the operation command is performing the operation command in a time between a first change of n changes to a busy state and a last return of n returns to a ready state.

15. An interleaving control method of a memory system for changing a memory area as a target of an operation command every time the operation command is transmitted to a plurality of nonvolatile memory areas capable of individually operating and individually outputting a ready/busy signal, thereby interleaving an operation in the memory areas, the method comprising:
selecting a memory area with a highest level of selection priority from the memory areas in a ready state based on a level of selection priority of each memory area set beforehand, to designate the selected memory area as a memory area as a target of the operation command;
transmitting the operation command to the memory area as the target of the operation command; and
shifting the level of selection priority of the selected memory area at a time of next selection to a lowest level.

16. The interleaving control method of a memory system according to claim 15, wherein the operation of the memory area includes data write, data read, and data erasure, and the memory area changes a ready/busy signal connected to the memory area itself to a busy state while the operation is being performed, and to a ready state while the operation is not being performed.

17. The interleaving control method of a memory system according to claim 15, wherein each of the memory areas is a bank constituted by a plurality of NAND flash memories, to which a ready/busy signal is commonly connected.
